(19) United States
(12) Patent Application Publication
(10) Pub. No.: US 2013/0322082 A1
(43) Pub. Date: Dec. 5, 2013

(54) MODULAR LIGHT EMITTING DIODE (LED) LIGHTING FIXTURES

(71) Applicant: Metrolight Ltd., Netanya (IL)

(72) Inventor: Jonathan Hollander, Petach Tikva (IL)

(21) Appl. No.: 13/909,148

(22) Filed: Jun. 4, 2013

(30) Foreign Application Priority Data
Jun. 4, 2012 (GB) 1209907.3

(51) Int. Cl. F21S 2/00

(52) U.S. Cl. CPC F21S 2/005
USPC 362/249.02

(57) ABSTRACT

A lighting fixture include a printed circuit board (PCB) and multiple light emitting diodes. Multiple connection terminals are electrically connected to the printed circuit board including alternating current (AC mains) connection terminals and communications connection terminals. A communications interface is electrically connectible to the communications connection terminals adapted to provide communications addressable to the control circuit. A communications signal for controlling the operating parameter is transferable to the communications interface via the other lighting fixture through the communications connection terminals.

### CROSS REFERENCE TO RELATED APPLICATIONS

The present application claims priority from United Kingdom Intellectual Property Office patent application GB1209907.3 filed 04 Jun. 2012 the disclosure of which is incorporated herein by reference.

### BACKGROUND

1. Technical Field

The present invention relates to modular illumination fixtures and particularly to illumination fixtures using light emitting diodes (LEDs).

2. Description of Related Art

Light emitting diodes (LEDs) are becoming more widely used in consumer lighting applications. In consumer applications, one or more LED dies (or chips) are mounted within a LED package or on a LED module, which may make up part of a LED lighting fixture. Various implementations of LED lighting fixtures are becoming available in the marketplace to fill a wide range of applications. LEDs offer improved light efficiency, a longer lifetime, lower energy consumption and reduced maintenance costs, as compared to high intensity discharge (HID) light sources for example.

### BRIEF SUMMARY

According to features of the present invention, various lighting fixtures are provided herein which include a printed circuit board (PCB) and multiple light emitting diodes electrically interconnected and mechanically mounted to a first side of the printed circuit board. The light emitting diodes are configured to provide illumination in the environment of the lighting fixture. A driver circuit has an input adapted to receive power from an alternating current (AC) mains supply and an output configured to provide a driving power to the light emitting diodes. Multiple connection terminals are electrically connected to the printed circuit board including alternating current (AC mains) connection terminals and communications connection terminals. The AC mains electrical connection terminals are electrically connectible to the AC mains supply via another like lighting fixture. The connection terminals may be adapted to couple directly with the other like lighting fixture by electrically connecting pins between the respective connection terminals of the lighting fixture and of the other lighting fixture.

A control circuit, connected to the driver circuit, is configured to control an operating parameter of the driver circuit. The operating parameter may be a drive voltage, a drive current, a driver power and/or color temperature of said LEDs. The operating parameter may be configurable to dim the light output of the light emitting diodes. The lighting fixture may be addressable to individually control thereby the operating parameter of the driver circuit. A communications interface is electrically connected to the communications connection terminals adapted to provide communications addressable to the control circuit. A communications signal for controlling the operating parameter is transferable to the communications interface via the other lighting fixture through the communications connection terminals. The driver circuit may be mountable on a second side of said PCB opposite said first side. Alternatively, the driver circuit may be mountable on the first side of the PCB and a heat transfer plate may be mounted flush to the second side of said PCB opposite the first side. The printed circuit board may be the only printed circuit board in the lighting fixture. The AC connection terminals are configured to input the AC mains supply from the other like lighting fixture and second AC connection terminals may configured to output the AC mains supply to a third like lighting fixture. The light emitting diodes may be distributed throughout the first side of the printed circuit board to maximize heat dissipation. A connector housing may be adapted for mounting the connection terminals. The connection housing may be mechanically adapted to provide a mechanical connection to said other lighting fixture. The AC connection terminals provide the AC mains supply to a multiple other like lighting fixtures.

The first side of the printed circuit board may be substantially white in color. The light emitting diodes (LEDs), the number of LEDs and the current supplied are selected so that said lighting fixture is operable at a minimal electrical power rating of 20 watts. The number of LEDS per area on substantially all the first side of the printed circuit board may be between 0.25 LEDs per square centimeter and 1 LED per square centimeter. A controlled current source operatively attached to said control circuit may be configured to control the operating parameter applied to driver of the light emitting diodes. An on-board non-volatile memory may be adapted to store an address. The lighting fixture may include an attachment mechanism adapted for connection to a ceiling of a room for illumination of the room.

Various modular lighting system are provide for room illumination including multiple inter-connectible lighting fixtures. AC mains and communications connection terminals are adapted to couple directly with the other like lighting fixture(s) by electrically connecting pins insertable between the respective connection terminals of the lighting fixture and of the other lighting fixture(s).

According to a feature of the present invention there is provided a printed circuit manufactured for assembly of the lighting fixture.

According to a feature of the present invention, a modular lighting system is provided for room illumination includes multiple inter-connectible lighting fixtures as disclosed herein. The connection terminals may be adapted to couple directly with the other like lighting fixture by electrically connecting pins, insertable between the respective connection terminals of the lighting fixture and of the other lighting fixture. The modular lighting system includes pins disposed between the respective connection terminals operable to electrically connect to AC mains at least three of the inter-connectible lighting fixtures. The pins may be insertable and removable to electrically connect or electrically isolate any of the inter-connectible lighting fixtures while maintaining a mechanical connection.

According to features of the present invention, a method for controlling a modular lighting system for illumination in the environment. The modular lighting system uses multiple lighting fixtures. Each lighting fixture includes a printed circuit board, multiple light emitting diodes electrically inter-connectible and mountable on a first side of the printed circuit board. The light emitting diodes are configured to provide the illumination.

A driver circuit having an input adapted to receive power from an alternating current (AC) mains supply and an output configured to provide a driving current to the light emitting diodes. A control circuit is configured to control an operating parameter of the driver circuits. Connection terminals are electrically and mechanically connected to the printed circuit board. The connection terminals include AC connection terminals and communications connection terminals. A communications interface to the communications connection terminals provides addressable communications to the control circuit. AC mains are coupled directly with at least one other like lighting fixture by electrically connecting pins between the respective connection terminals of the lighting fixture and of the at least one other lighting fixture. Delivery of current to the light emitting diodes is addressably controlled by a control signal transmittable through the communications connection terminals via another lighting fixture.

Color of light emission of the LEDs may be controlled by controlling delivery of current to different types of LEDS in at least two of the lighting fixtures. The control signal is communicated between at least two of the light fixtures for controlling the color of light emission of the LEDs. The control signal is communicated for controlling a photometric brightness of the LEDs.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The invention is herein described, by way of example only, with reference to the accompanying drawings, wherein:

FIG. 1 shows a block system diagram of a lighting fixture circuit, according to a feature of the present invention.

FIGS. 2a shows a plan view of the lighting fixture circuit of FIG. 1 as mounted on a printed circuit board (PCB), according to a feature of the present invention.

FIGS. 2b and 2c show respectively two layouts in side view of the lighting fixture circuit of FIG. 1 according to aspects of the present invention.

FIG. 2d shows a side view of a circuit mounted on PCB, according to a another embodiment of the present invention.

FIG. 2e shows a plan view, according to a feature of the present invention.

FIG. 3 shows details of a LED with a plan and side view of the LED, according to an aspect of the present invention.

FIG. 4a shows details of a hanging lighting fixture, according to an aspect of the present invention.

FIGS. 4b and 4c show details of another ceiling mounted lighting fixture 40b, according to an aspect of the present invention.

FIGS. 4d, 4e and 4f show examples of triangular, rectangular and hexagonal shapes for circuit boards respectively, as configurations for a lighting fixture, according to an aspect of the present invention.

FIG. 5 shows a method, according to an aspect of the present invention.

FIG. 6 shows an exemplary inter connections of multiple LEDs according to a feature of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

By way of introduction, embodiments of the present invention are directed to modular light emitting diode light systems for illumination. According to features of the present invention, the lighting modules may include a single printed circuit board which on one side, white illumination LEDs are distributed throughout and on the other side the LED driver circuitry is mounted, supplied by the AC mains voltage. Since each lighting module includes its own driver circuitry to drive the LEDs supplied by the AC mains voltage, additional lighting modules may be added later, simply by connecting together with the installed modules in which the connectors supply AC and communications functionality. In this way, a large number of additional modules may be added after the original as a retrofit. Moreover, embodiments of the present invention avoid prior design and installation of a central driver circuit for modular LED illumination system and addressable communications are provided for selectively controlling color, photometric brightness e.g. dimming the individual light fixtures and/or selection of LEDS with different features e.g. different LED-lens pairs within one or more light fixtures.

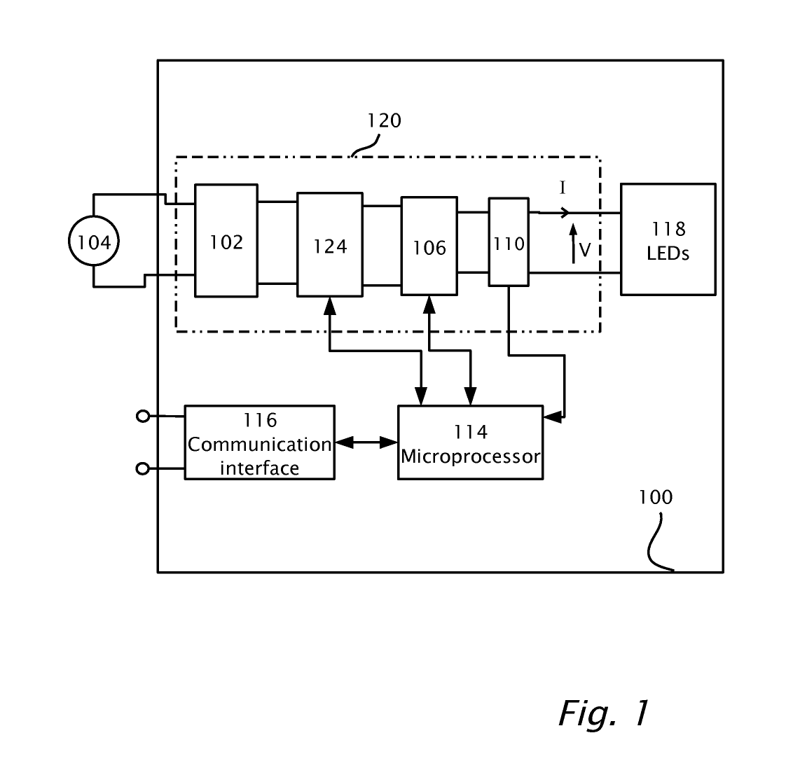

Referring now to the drawings, FIG. 1 shows according to a feature of the present invention, a block diagram of a LED lighting fixture circuit 100. Circuit 100 has an input connectible to an alternating current (AC) power supply or mains voltage 104 and an output connected to a bank of light emitting diodes (LEDs) 118, suitably interconnected in series and/or in parallel on a printed circuit board (PCB) for example. Circuit 100 includes a driver circuit 120. Driver circuit 120 includes connected in order, a rectifier circuit 102, a power factor correction (PFC) circuit 124 and a power converter circuit 106. Power factor correction (PFC) circuit 124 and a power converter circuit 106 may be connected to and be under monitor and/or control of control circuit or microprocessor 114. Microprocessor 114 may have access to addressable on board non-volatile memory (not shown) which may include both read only or random access memory. An impedance sensor (current and/or voltage sensor) 110 is shown connected to the output of power converter 106.

Rectifier 102 has a mains electricity input 104 supplied from a utility grid for example. Input 104 is typically a 120/240 root mean square (RMS) alternating current (AC) voltage with a frequency of 60/50 Hertz. Rectifier 102 rectifies mains electricity input 104 to produce a varying direct current (DC) output which is input into power factor correction (PFC) circuit 124. The DC output of PFC 124 is connected to the input of converter circuit 106, converter 106 may be a “half bridge” or a “full bridge” type of converter circuit. Converter 106 may convert the DC output of PFC 124 to an AC output of converter 106 or a direct current (DC) output output of converter 106 if converter 106 is a DC to DC converter. The AC output of converter 106 and hence the output of driver circuit 120 may be changed to DC via a rectifier located on the output of converter 106 or located in impedance sensor 110 (current and/or voltage sensor) connected to the output converter 106.

The output of converter circuit 106 may be a controlled AC current output which may be a high frequency output or a low frequency output. For a high frequency output, the AC output of converter 106 may be sinusoidal with a frequency typically of 100 kHz or more. Low frequency AC output of converter 106 may be sine wave, a square wave or triangular wave at about 160 Hertz.

A communications interface 116 may be connected to microprocessor 114 to enable external programming and/or reprogramming of circuit 100 operating parameters which may include output current (I) and/or voltage (V) of circuit 100 for example. Sensing of circuit 100 operating parameters by sensor 110 may allow for a bank of light emitting diodes (LEDs) 118 of various series parallel or parallel interconnections to operate with a DC output and/or AC output from converter 106. Circuit 100 may be uniquely addressable in an installation of multiple circuits 100 for example. The address may be used to individually set the operating parameters of circuit 100 by a central controller or a computer (not shown) attached to communication interface 116. The controller or computer may be attached to communication interface 116 wirelessly or by a hard wire cable. The operating parameters of circuit 100 may be set prior to the installation of the lighting fixture or subsequent to the installation. The operating parameters of circuit 100 (output current (I) and/or voltage (V)) may be altered to control the color temperature of LEDs 118 and/or to dim LEDs 118 for example.

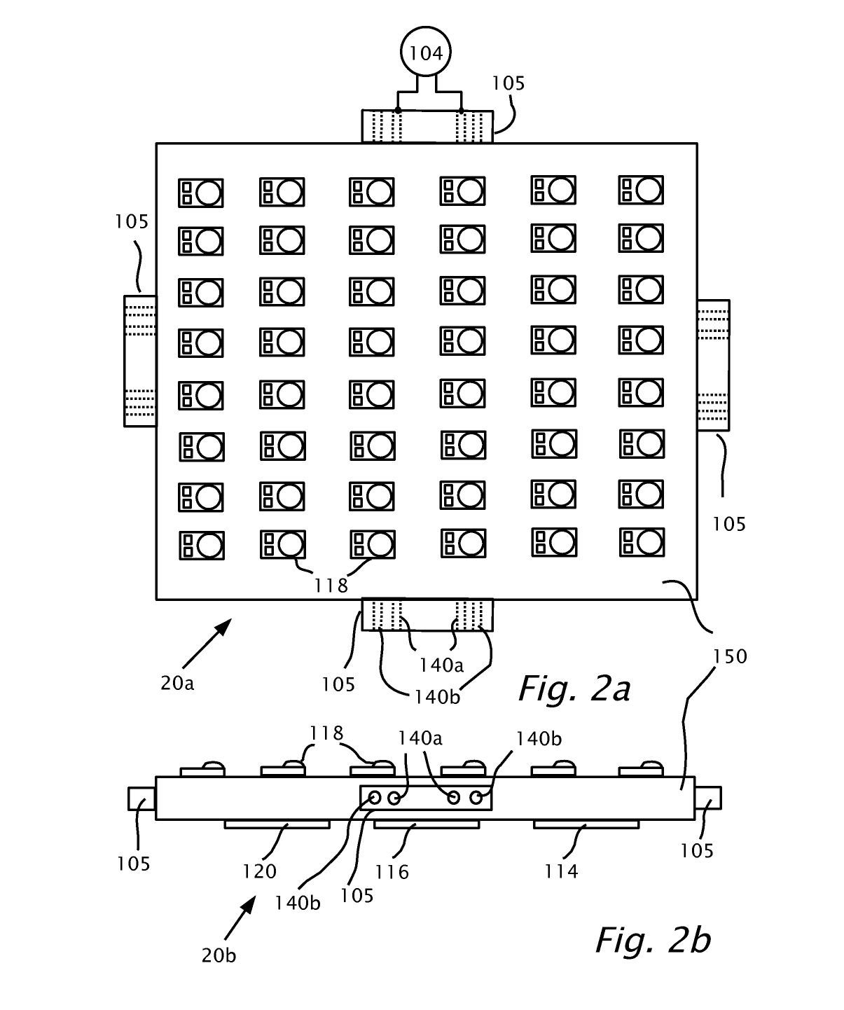

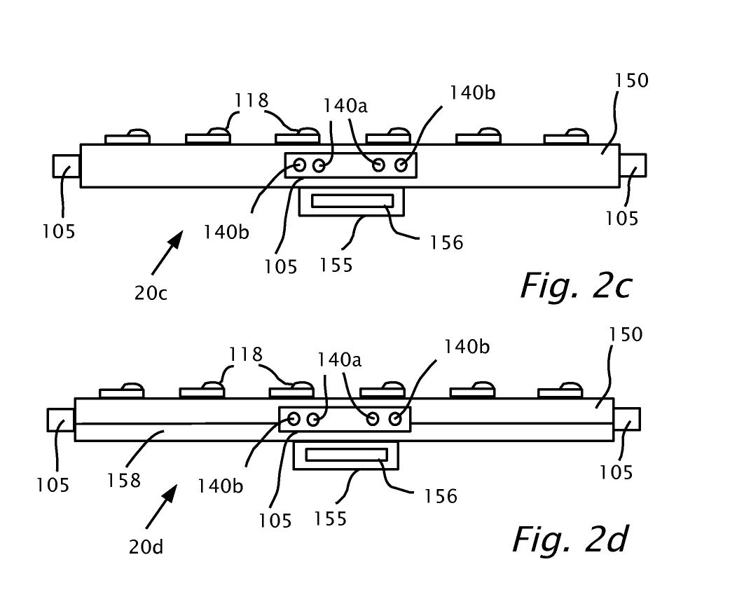

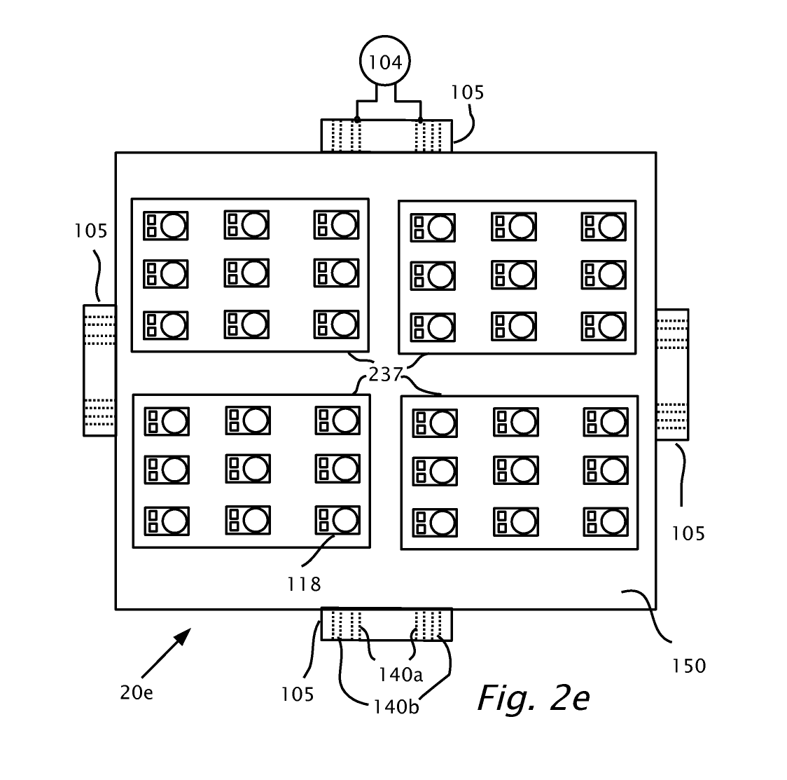

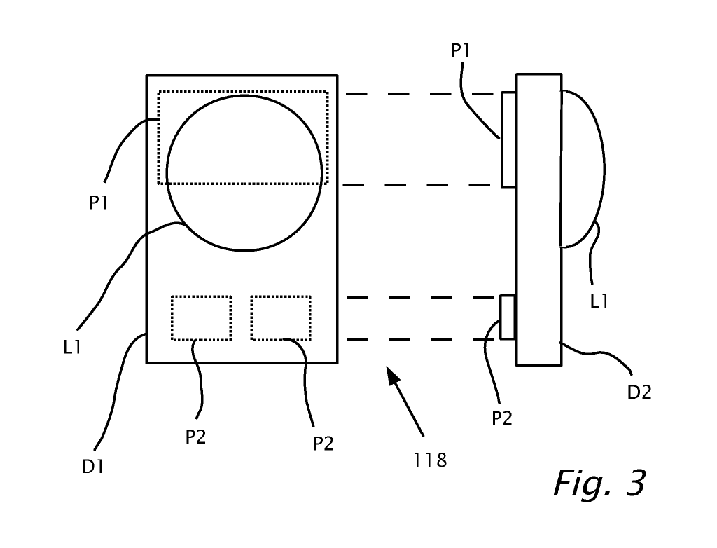

Reference is now made to FIGS. 2a and 2b which show a plan view 20a and a side view 20b respectively of circuit 100 mounted on PCB 150, according to a feature of the present invention. Plan view 20a shows multiple LEDs 118 on the surface of PCB 150. A number density of LEDs 118 may be of the order of 0.25 to 1 LEDs 118 per square centimeter for example. LEDs 118 may be distributed evenly throughout the surface of PCB 150 to ensure maximum surface area between LEDs 118 and increased heat dissipation from PCB 150. The surface as shown in view 20a of printed circuit board (PCB) 150 may be white in color so as to reflect light from LEDs 118 and/or may be another color for the purpose cosmetic/aesthetic appearance of lighting fixture. Connector housing 105 is shown mounted on multiple sides of circuit 100 with an AC mains supply 104 connectible by connection terminals 140a. Connection terminals 140a provide electrical connection of mains supply 104 to circuit 100 and another pair of connection terminals 140b provide electrical connection of communication interface 116 to circuit 100. Connector terminals 105 may be positioned on the edge of printed circuit board 150 or on the surface of printed circuit board 150 which allows a connection between multiple circuits 100 where there is substantially no gap between circuits 100 when interconnected.

Side view 20b shows multiple LEDs 118 connected on one side of circuit 100 and on the other side of circuit 100, driver circuit 120, communication interface 116 and microprocessor 114. Driver circuit 120, communication interface 116 and microprocessor 114 may be implemented at least in part as an application-specific integrated circuit (ASIC) and may alternatively be mounted on the same side as LEDs 118 are mounted on circuit 100.

Connection terminals 140a/140b may implemented as female connector terminals, e.g. apertures 140a/140b which may be converted into male terminals by insertion of a round conductive pin into aperture 140. Having one female connector 105 on one circuit 100 and one male connector 105 on another circuit 100, allows two circuits 100 to be connected together electrically and mechanically. The interconnection of male and female connectors 105 of respective circuit 100 may be not polarity specific as it may be if a DC supply were used to connect and to supply power to a circuit 100.

FIG. 2c shows a side view 20c of circuit 100 mounted on PCB 150, according to a another embodiment of the present invention. In side view 20c, a housing 155 is shown with a circuit board 156 which connects electrically to connector 105. Circuit board 156 may include a driver circuit 120 to drive LEDs 118, microprocessor 114 and communications interface 116. Circuit board 156 may be socket mount or solder mount to circuit board 150.

FIG. 2d shows a side view 20d of circuit 100 mounted on PCB 150, according to a another embodiment of the present invention. Side view 20d includes all of the parts shown in view 29c and further includes a heat transfer plate 158. Heat transfer plate 158 in thermal contact with the back ground plane of circuit board 150. Heat transfer plate 158 functions to conduct heat away from circuit board 150 while board 150 operates. An optional thermal pad or other thermal conductive material may be disposed between circuit board 150 and heat-transfer-plate 158 to improve heat conduction from circuit board 150. Heat transfer plate 158 may be similarly incorporated in the embodiment shown in side view 20b. When circuits 100 are butted together so that terminal connectors 105 of respective circuits 100 connect electrically and/or mechanically together there may be also a thermal connection to allow thermal conduction between respective heat transfer plates 158. Housing 155 is shown with a circuit board 156 (which connects electrically to connector 105), located on the opposite side to LEDs 118. Alternatively housing 155 and board 156 and/or driver circuit 120 may be located on the same side as LEDs 118 so that heat transfer plate 158 lies flush on the other side of circuit board 150.

Reference is now made to FIG. 2e which shows a plan view 20e, according to a feature of the present invention. Plan view 20e shows arrays 237 of LEDs 118 mounted and interconnected on circuit board 150 which provides connections to housing 155, board 156 and/or driver circuit 120 and connectors 105. Arrays 237 have interconnected LEDs 118 mounted on a board which can bolt down onto a circuit board 150 or heat-transfer plate 158. The board bolted down onto heat-transfer plate 158 is further connected to housing 155, board 156 and/or driver circuit 120 and connectors 105 for example. Housing 155 and board 156 and/or driver circuit 120 may be located on the same side as arrays 237 or on the opposite side of arrays 237.

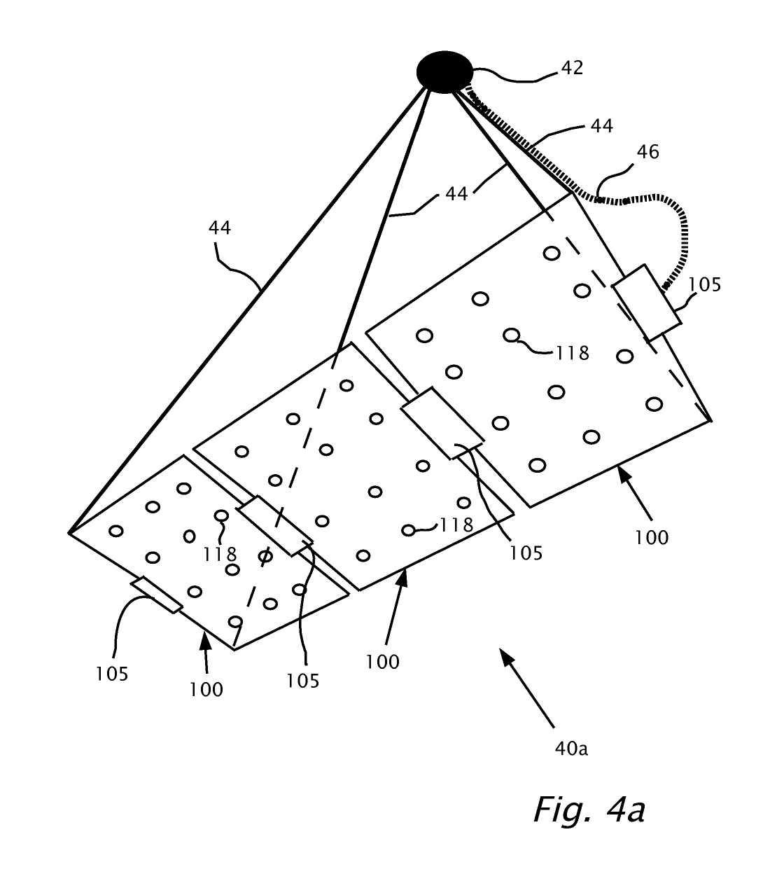

Reference is now made to FIG. 3 which shows more details of LED 118 with a plan and side view of LED 118, according to an aspect of the present invention. Multiple LEDs 118 are mounted on circuit 100. LEDs 118 may be Philips Lumileds™, LUXEON Rebel ES™, part number LXW8-PW40 for example, which provide a thermal pad P1, anode pad P2 and cathode pad P3 and lens L1 mounted on a die D1. Thermal pad P1 is mounted on a thermally conductive but electrically non-conductive front portion of circuit 100. A feature of the LUXEON Rebel ES LED™ is that a failure of an LED leaves a short circuit around the LED so a serial string of LEDs may still operate.

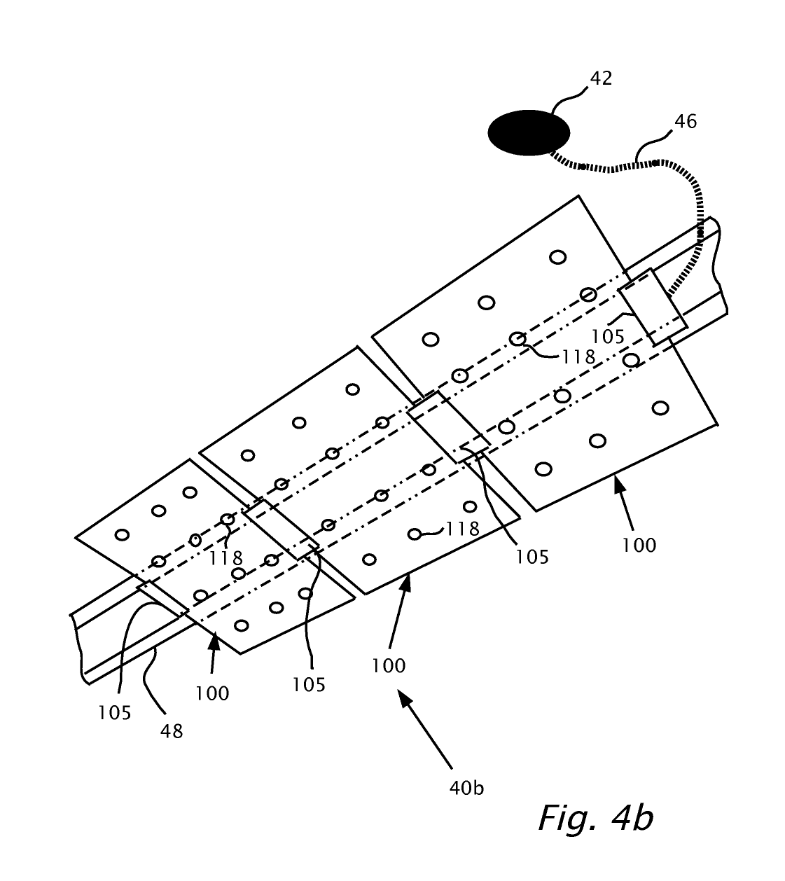

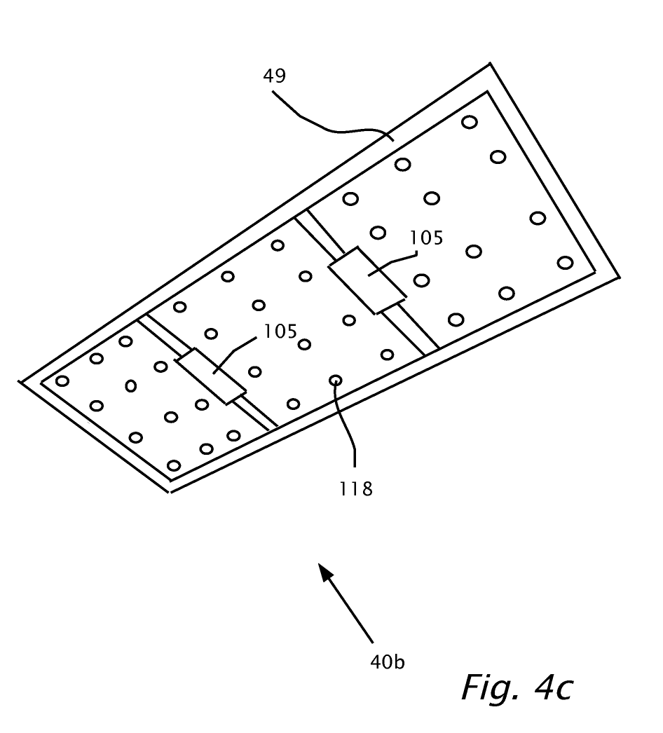

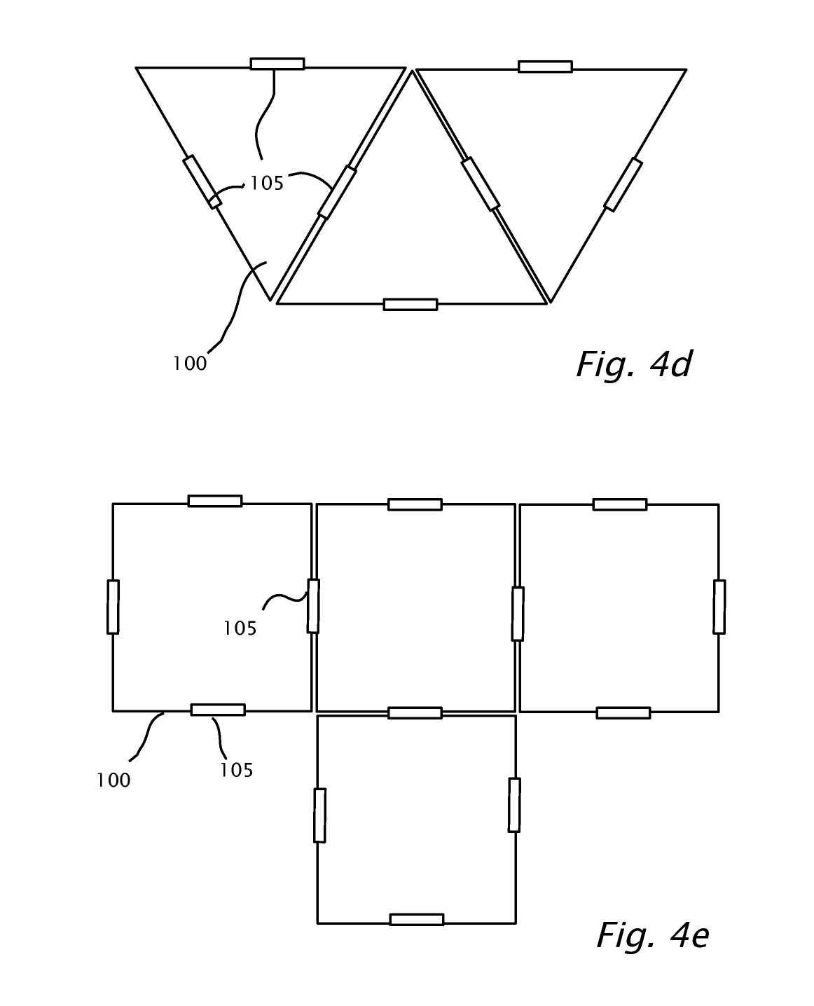

Reference is now made to FIG. 4a which shows details of a lighting fixture 40a, according to an aspect of the present invention. lighting fixture 40a has three circuits 100 with LEDS 118. The three circuits 100 are shown connected together electrically in a line via two connector terminals 105. lighting fixture 40a including the three circuits 100 may be suspended from a ceiling, cable tray, lighting rail or joist for example, with four cables 44 mechanically attached at one end to a ceiling junction box 42 which is attached to the ceiling, cable tray, lighting rail or joist. The other ends of cables 44 being attached to lighting fixture 40a. An electrical cable 46 provides AC mains supply 104 from ceiling junction box 42 to connector terminal 105. The connection of the other two circuits 100 via two connector terminals 105 provides AC mains supply 104 to the other two circuits 100. Electrical cable 46 may further provide additional wires for a communication connection to connector terminal 105 and further communication to the other two circuits 100, again by virtue of the two other connector terminals 105 being connected together. Power line communications may be alternatively used to provide the communication connection to circuits 100.

Reference is now made to FIG. 4b which shows more details of another LED lighting fixture 40b, according to an aspect of the present invention. lighting fixture 40b including three circuits 100 is mounted on din rail 48. Din rail 48 may allow circuits 100 to be slid and butted together so that terminal connectors 105 of respective circuits 100 connect electrically and/or mechanically together. AC cable 46 to junction box 42 is also shown connecting to connector 105 of one of circuits 100.

Reference is now made to FIG. 4c which shows lighting fixture 40b, fully assembled and mounted on a ceiling according to an aspect of the present invention. LEDs 118 appear on the white colored background of the front surface of PCB 150. A frame 49 covers the edges of PCB 150 for improved aesthetic design. A similar frame 49 may also be used with lighting fixture 40a shown in FIG. 4a.

The communication connection may allow individual communication and control of a circuit 100 in a lighting fixture 40a/b by virtue of each circuit 100 being uniquely addressable. Multiple light fixtures 40a/b may be placed in an architectural layout where needed in an installation with each lighting fixture 40a/b having the same mains power supply 104. The layout may be stored in a central memory of a central controller for example, which may allow for individual control of a lighting fixture 40a/b with respect dimming the light intensity of the lighting fixture 40a/b and/or the color temperature of the lighting fixture 40a/b. The operating parameters of multiple circuits 100 in an installation of multiple fixtures 40a may be set or controlled prior to the installation or subsequent to the installation.

FIGS. 4d, 4e and 4f show exemplary features of triangular, rectangular and hexagonal shapes for circuit boards 100 respectively, which are electrically and optionally mechanically attached to each other with respective connector terminals 105 to give numerous possible configurations for lighting fixture 40. It is readily seen that lighting fixtures 40 in FIGS. 4e and 4f are mountable on a planar surface, e.g. room ceiling in a non-collinear configuration as opposed to the examples shown in FIG. 4c which is a collinear design. As such there is an extremely large versatility in terms of architectural utility and design.

Referring now to particularly to FIG. 4f, by way of example circuits 100 are shown to be connected in a radial manner to provide modular lighting fixtures 40.

The term “radial” as used herein in the context of a “radial” circuit which refers to a circuit which has AC mains power fed to lighting points in succession. The feed of AC mains power goes to the first lighting point and then goes on to the next lighting point. The circuit terminates with the last lighting point on the circuit. The last lighting point or any other lighting point apart from the first lighting point does not return to the source AC mains power.

In FIG. 4f, a radial path is shown by a dotted line 400 passing through circuits 100 labeled as A, B, C, D and E. Radial path 400 to connecting AC mains 104 from lighting fixture 40 to lighting fixture 40 is via terminal connectors 105 on each circuit 100. Dotted line 400 passes through the terminal connectors 105 which may be connected together electrically with pins inserted in respective connector terminals 140a to allow radial connection circuits 100 from A to B, B to C, C to D and D to E. To avoid short circuit between live and neutral of AC mains 104, pins are not inserted or removed from terminal connectors 105 labeled as X, Y and Z. Alternatively, electrically insulating pins may be inserted into terminal connectors 105 labeled as X, Y and Z to provide mechanical attachment and no electrical connection of circuits E and D to A, B and C. Therefore, the connection of male and female connectors 105 of respective circuits 100 may be implemented without having to provide two types of connector 105 to preserve polarity.

Alternatively terminal connectors 105 may have pins 140a for AC power connection and pins 140b for communications which are located in respective geometric planes perpendicular the geometric plane of defined by the surface of PCB 150. The plane of PCB 150 is shown in FIG. 2a. In this way, if connections to lighting fixtures 40 loop back to the source, short circuits may be avoided between live and neutral of AC mains 104 with respect to pins 140a and similar potential short circuit with respect to communication interface 116 and pins 140b.

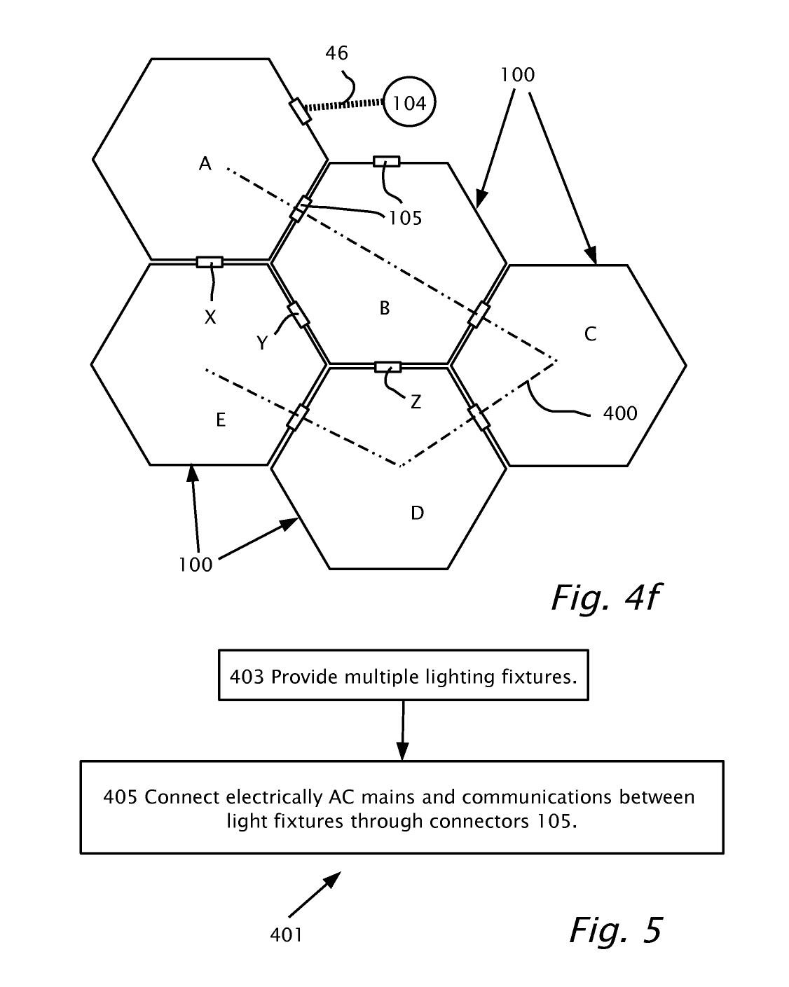

Reference is now made to FIG. 5 shows a method of providing room illumination, according to an aspect of the present invention. Multiple light fixtures 40 are provided (step 403). Light fixtures 40 are connected to mains AC voltage 104 and addressable communications is provide by interconnecting (step 405) connectors 105.

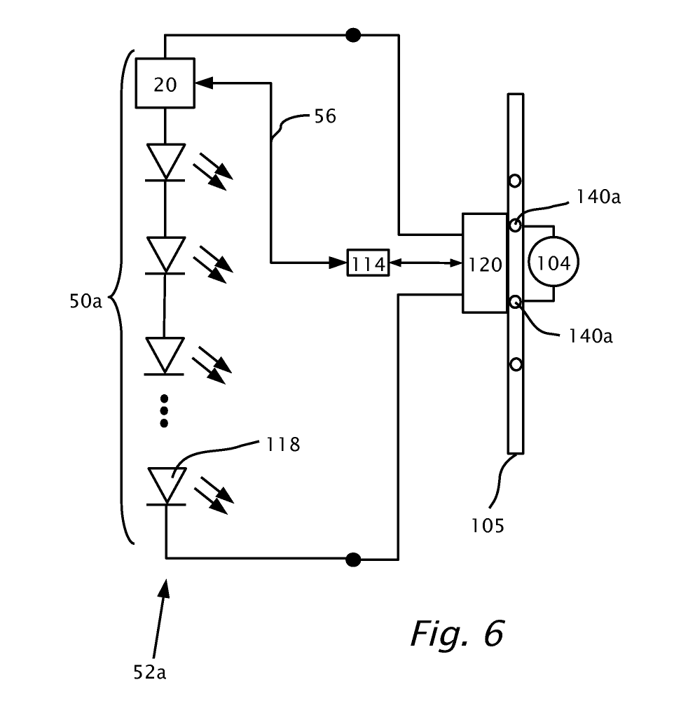

Reference is now made to FIG. 6 which shows a simplified schematic circuit diagram 52a as part of circuit 100, according to a feature of the present invention. As shown previously, connector terminal 105 provides connection of driver circuit 120 input to AC mains supply 104 at terminals 140a. Driver circuit 120 is operatively attached to microprocessor 114. The output of driver circuit 120 is connected in parallel across an LED string 50a. String 50a includes multiple LEDs 118 connected in series and further connected in series with current controlled source 20. Control of current is performed via a control line 56 which is connected between microprocessor 114 and current controlled source 20. String 50a is controlled so as to determine the amount of current flowing in each string 50a. String 50a may be driven from either an AC or a DC output from driver 120.

In an exemplary design of a 100 Watt (W) lighting fixture 40 using four circuits 100, the number of LEDs 118 and the current supplied when the LEDs 118 may be decided. This example assumes a typical current operating range of forward current for an LED 118 between 350 milli-Amperes (mA) and 1 Ampere. In this example each circuit 100 has a single LED string 50a but may also have multiple interconnected LED strings 50a and/or each string 50a individually controlled with its respective current controlled source 20. Data sheet for LED 118 for forward current of 350 mA; gives a forward voltage of 2.85 Volts (V) and 1 W per LED, giving a flux of 130 lumens at a color temperature of 4100 kelvin; for forward current of 700 mA; gives a forward voltage of 3.0V and 2.1 W per LED and for a forward current of 1 A; a forward voltage of 3.1V and 3.1 W per LED. For a total 100 W electrical power rating for fixture 40 means that each circuit 100 will consume 25 W. Keeping current consumption low by LEDs 118 (LUXEON Rebel ES LED™ for example) and noting that luminous efficacy increases with lower forward current of LED 118, gives less heat dissipated by LEDs 118. The number of LEDs per circuit 100 is 25 Watts divided by 1 Watt, giving 25 LEDs 118 per circuit 100. For a comparable power rating for LED fixture 40 with a high intensity discharge (HID) lamp fixture of 160 W, gives 40 W divided by 1 W, giving 40 LEDs 118 per circuit 100.

Color characteristics of the LED illumination may be adjusted in a circuit 100 by virtue of circuit 100 being uniquely addressable in an installation of multiple circuits 100 for example includes individual control of each string 50a in a circuit 100. Using the example of two strings 50a connected in parallel, current controlled source 20 for each string 50a receives a control signal from microprocessor 114. The control signal controls also driver circuit 120 that drives two strings 50a connected in parallel so that the current between two strings 50a is divided to adjust the color of the illumination from circuit 100 for each string 50a.

The term “illumination” as used herein refers to the provision of visible light in the environment typically white light to enable or improve visibility of objects in the environment.

The term “photometric” as used herein refers to a measurement of light, in terms of perceived brightness to the human eye.

The term “white light” as used herein refers visible light when all or most of the colors of the visible light spectrum are combined.

The term “drive” or “driver” as in “a drive current” for example, refers to an electrical circuit or other electronic component used to provide the power to another circuit or other component. Control of the drive current may be by a microprocessor for example.

The terms “microprocessor” and “microcontroller” as used herein are used interchangeably.

The term “control circuit” as used herein may be implemented in a “microprocessor” and “micro-controller” or in a dedicated control circuit.

The term “pins” as used herein for electrical connections may be male or female and may have any geometric cross section.

The terms “computer” and “central controller” are used herein interchangeably.

The indefinite articles “a”, “an” is used herein, such as “a printed circuit board”, “a connector” have the meaning of “one or more” that is “one or more printed circuit boards” or “one or more connectors”.

Although selected features of the present invention have been shown and described, it is to be understood the present invention is not limited to the described features. Instead, it is to be appreciated that changes may be made to these features without departing from the principles of the invention, the scope of which is defined by the claims and the equivalents thereof.

What is claimed is:

1. A lighting fixture comprising:
a printed circuit board (PCB);
a plurality of light emitting diodes electrically interconnected and mechanically attached to the printed circuit board, wherein said light emitting diodes are mountable on a first side of said PCB, wherein said light emitting diodes are configured to provide illumination in the environment of the lighting fixture;
a driver circuit with an input adapted to receive power from an alternating current (AC) mains supply and with an output configured to provide a driving power to the light emitting diodes;
a plurality of connection terminals electrically connected to the printed circuit board including AC connection terminals and communications connection terminals wherein said AC electrical connection terminals are electrically connectible to the AC mains supply via another like lighting fixture; and
electrically connecting pins; wherein said connection terminals are adapted to couple directly with said other like lighting fixture by said electrically connecting pins between the respective connection terminals of the lighting fixture and of the other lighting fixture;
a control circuit operatively connected to said driver circuit, wherein said control circuit is configured to control an operating parameter of said driver circuit;
a communications interface electrically connected to said communications connection terminals adapted to provide communications addressable to said control circuit; and
wherein a communications signal for controlling said operating parameter is transferable to said communications interface through said communications connection terminals via said other lighting fixture.

2. The lighting fixture of claim 1, wherein the driver circuit is mountable on a second side of said PCB opposite said first side.

3. The lighting fixture of claim 1, wherein the driver circuit is mountable on said first side of said PCB, the lighting fixture further comprising:
a heat transfer plate mountable flush to the second side of said PCB opposite said first side.

4. The lighting fixture of claim 1, wherein said AC connection terminals are configured to input the AC mains supply from the other like lighting fixture and second AC connection terminals are configured to output the AC mains supply to a third like lighting fixture.

5. The lighting fixture of claim 1, wherein the light emitting diodes are distributed throughout the first side of the printed circuit board.

6. The lighting fixture of claim 1, further comprising:
a connector housing adapted for mounting said connection terminals, wherein said connection housing is mechanically adapted to provide a mechanical connection to said other lighting fixture.

7. The lighting fixture of claim 1, wherein said AC connection terminals provide said AC mains supply to a plurality of other like lighting fixtures.

8. The lighting fixture of claim 1, wherein said operating parameter is selected from the group consisting of: a drive voltage, a drive current, a driver power and color temperature of said LEDs.

9. The lighting fixture of claim 1, wherein said operating parameter is configurable to dim the light output of said light emitting diodes.

10. The lighting fixture of claim 1, wherein said first side of the printed circuit board is substantially white in colour.

11. The lighting fixture of claim 1, wherein the light emitting diodes (LEDs), the number of LEDs and the current supplied are selected so that said lighting fixture is operable at a minimal electrical power rating of 20 watts.

12. The lighting fixture of claim 1 further comprising a controlled current source operatively attached to said control circuit and configured to control said operating parameter applied to the light emitting diodes.

13. The lighting fixture of claim 1, further comprising:
an on board non-volatile memory adapted to store an address, whereby the lighting fixture is addressable to individually control thereby said operating parameter of said driver circuit.

14. The printed circuit board of claim 1 manufactured for assembly of the lighting fixture of claim 1.

15. A modular lighting system for room illumination including a plurality of inter-connectible lighting fixtures of claim 1, wherein said AC and communications connection terminals are adapted to couple directly with said other like lighting fixture by electrically connecting pins insertable between the respective connection terminals of the lighting fixture and of the other lighting fixture.

16. The modular lighting system of claim 15, further comprising
pins disposed between the respective connection terminals operable to electrically connect to AC mains at least three of the inter-connectible lighting fixtures, wherein said pins are insertable and removable to electrically connect or electrically isolate any of the inter-connectible lighting fixtures while maintaining a mechanical connection.

17. A method for controlling a modular lighting system for illumination in the environment using a plurality of lighting fixtures, each lighting fixture including:
a printed circuit board,
a plurality of light emitting diodes electrically inter-connectible and mountable on said printed circuit boards, wherein said light emitting diodes are configured to provide the illumination,
a driver circuit with an input adapted to receive power from an alternating current (AC) mains supply and with output configured to provide a driving current to the light emitting diodes,
a plurality of connection terminals electrically and mechanically connected to the printed circuit board, wherein the connection terminals include AC connection terminals and communications connection terminals, wherein said AC electrical connection terminals are electrically connectible to the AC mains supply via another like lighting fixture; and
electrically connecting pins; wherein said connection terminals are adapted to couple directly with said other like lighting fixture by said electrically connecting pins between the respective connection terminals of the lighting fixture and of the other lighting fixture;
a control circuit configured to control an operating parameter of said driver circuits, and
a communications interface to said communications connection terminals to provide addressable communications to the control circuit, the method comprising the steps of:
for at least one of said lighting fixtures:
enabling coupling of the AC mains directly with at least one other like lighting fixture by electrically connecting pins between the respective connection terminals of the lighting fixture and of said at least one other lighting fixture; and
addressably controlling delivery of current to the light emitting diodes by a control signal transmittable through said communications connection terminals via said at least one other lighting fixture.

18. The method of claim 17, further comprising:
controlling color of light emission of the LEDs by said controlling delivery of current to different types of LEDS in at least two of the lighting fixtures.

19. The method of claim 18, further comprising:
communicating said control signal for controlling said color of light emission of the LEDs between said at least two of the light fixtures.

20. The method of claim 17, further comprising:
communicating said control signal for controlling a photometric brightness of the LEDs.
